(19) United States
(12) Patent Application Publication
(10) Pub. No.: US 2007/0245889 A1
(43) Pub. Date: Oct. 25, 2007

(54) Hydraulic Control Arrangement

(75) Inventors: Alfred Breunig, Urspringen (DE); Karl Krug-Kussius, Karlsbach (DE); Joern Petersen, Simpsonville, SC (US)

Correspondence Address: OLIFF & BERRIDGE, PLC, P.O. BOX 19928, ALEXANDRIA, VA, 22320, US

(73) Assignee: Bosch Rexroth AG, Stuttgart (DE)

(21) Appl. No.: 11/631,779

(22) PCT Filed: Jun. 23, 2005
(86) PCT No.: PCT/EP05/06826

§ 371 Date: Feb. 21, 2007

(30) Foreign Application Priority Data
Jul. 22, 2004 (DE) 10 2004 035 632.7
May 10, 2005 (DE) 10 1005 022 275.7

(51) Int. Cl. F15B 13/14

(52) U.S. Cl. 91/418

(57) ABSTRACT

The invention relates to a hydraulic control arrangement and a pilot-operated pressure relief valve therefor. Said hydraulic control arrangement comprises a differential cylinder provided with a pressure chamber on the piston rod side thereof and another pressure chamber at the bottom thereof which can be connected to a pump or a tank by means of a control valve arrangement in order to actuate the differential cylinder. The pressure in a pressure chamber is defined by a pilot-operated pressure relief valve provided with a pressure switching stage by which means the pressure regulated by the pressure relief valve can be lowered according to the pressure in the other pressure chamber.

The invention relates to a hydraulic control arrangement comprising a differential cylinder in accordance with the preamble of claim 1 and a pilot-operated pressure relief valve suited for said control arrangement.

Control arrangements of this type are used especially in mobile working implements so as to swivel, for instance, a shovel of a wheel loader. In so doing, by extending a piston rod of a differential cylinder of the control arrangement the shovel is swiveled downward so as to empty, for instance, material collected therein. For collecting the material the piston rod of the differential cylinder is retracted so that the shovel swivels upward, i.e. away from the bottom. Such a solution is described, for instance, in U.S. Pat. No. 4,194,436. The differential cylinder is controlled in this case by a control valve to which a boost valve is connected. For retracting the differential cylinder (swiveling back the shovel) the control valve and the boost valve are brought into a position in which a pump of the control arrangement is connected to a piston rod side annular chamber and a bottom-side cylinder chamber is connected to a tank. For extending, the control valve and the boost valve are adjusted so that the cylinder chamber is connected to the pump and the piston rod side annular chamber is likewise connected to the cylinder chamber so that the pressure medium displaced therefrom is additionally guided into the cylinder chamber and, in this way, the extending movement of the differential cylinder is faster than in control arrangements without a differential circuit.

In U.S. Pat. No. 3,160,076 a similar control arrangement is disclosed for operating the shovel and the boom of a wheel loader, bulldozer or the like. In this case, the control arrangement is designed to include a pressure relief valve by which the load pressure is limited at the two hydraulic cylinders. The pressure relief valve includes a pressure switching stage which permits to limit, upon operation of the shovel, solely the load pressure to a higher pressure than it is the case upon operation of the boom or operation of both hydraulic cylinders.

In such control arrangements an overload and a collapse of the piston rod may occur by the action of external forces. This is the case, for instance, when the ground is to be drawn off and, in so doing, the shovel is swiveled downward and is placed onto the ground and then the wheel loader draws off the ground during reverse travel. If the shovel hits an obstacle during this drawing off, for instance a solid rock, the piston rod of the differential cylinder holding the shovel in the draw-off position is pressure-loaded and may collapse.

Compared to this, the object underlying the invention is to provide a hydraulic control arrangement and a pressure relief valve by which a differential cylinder of the control arrangement can be prevented from damage.

This object is achieved, as regards the hydraulic control arrangement, by the features of claim 1, and as regards the pressure relief valve, by the features of claim 14 or 15.

In accordance with the invention, the hydraulic control arrangement is designed to include a differential cylinder. The pressure chambers thereof can be connected via a control valve arrangement to a pump and a tank, respectively, so that a piston rod of the differential cylinder is extended or retracted. The pressure prevailing in the pressure chamber active in the supporting direction is limited by a pilot-operated pressure relief valve. The pilot stage thereof includes a pressure switching stage by which, with a low pressure prevailing in the other pressure chamber, the pressure adjusted at the pressure relief valve is lowered so far that an overload of the piston rod is reliably prevented. The pressure prevailing in the other pressure chamber is applied to a control surface of the pilot stage so that the limit pressure at which the pressure relief valve opens is variable in response to said pressure. Such a solution excels by an extremely simple compact design and an increased operating safety.

In accordance with the invention, it is especially preferred when the differential cylinder is controllable by the control valve arrangement in a differential circuit in which the annular chamber is connected to the cylinder chamber when the piston rod is extended.

The pressure switching stage preferably comprises a tensioning piston pressurizing a control spring of the pilot stage of the pressure relief valve to which piston in the direction of increase in the spring bias the pressure prevailing in the piston rod side annular chamber is applied and in the direction of reduction of the spring bias the pressure prevailing in the other pressure chamber (cylinder chamber) active in the supporting direction is applied, wherein the control surface of the tensioning piston active in this direction is smaller than the control surface active in the direction of increase in the spring bias.

The basic structure of a pressure relief valve used in the control arrangement according to the invention is known per se known from DE 100 62 428 A1 of the applicant. What is different from this solution in a preferred embodiment is that the tensioning piston of the pressure switching stage is pressurized in the direction of an increase in the bias of a control spring pressurizing a pilot-operated valve cone with a control pressure corresponding to a pressure prevailing in the other pressure chamber which is reduced upon the effect of an external force, if it is not yet the tank pressure. The pressure prevailing in the pressure chamber active in the supporting direction is applied to a smaller control surface active in the direction of reduction of the control spring bias. In the known solution, on the other hand, the pressure prevailing at the entrance of the pressure relief valve corresponding to the pressure prevailing in the pressure chamber active in the supporting direction is applied to the tensioning piston of the pressure switching stage in the direction of increase in the bias. In the direction of relief of the control spring, an external control pressure is applied to the tensioning piston in the known solution—this known pilot-operated pressure relief valve could not be used in the solution according to the invention without changes.

In a variant of the embodiment including a tensioning piston the smaller control surface is dispensed with.

In most applications the problem described in the beginning of an overload of the piston rod will occur when the latter is extended almost completely, i.e. in this case the pressure chamber active in the supporting direction is the bottom side cylinder chamber, while the other pressure chamber in which the pressure is reduced upon the effect of an external load is the piston rod side annular chamber.

The surface ratio between the control surface of the tensioning piston and the pilot-operated valve seat surface is <1,5 in an embodiment.

The control arrangement can be designed to be especially compact when a pilot-operated piston of the pressure relief valve is provided with a longitudinal passage through which control oil is guided from a spring chamber of a main stage of the pressure relief valve to the smaller control surface.

In such variant the pilot-operated piston is preferably designed to have a projection which immerses into a recess of the tensioning piston in a sealing manner. The end face of this recess then forms the smaller control surface, the active size of this surface being equal to the cross-sectional surface of the projection.

In an embodiment having an especially simple structure, the two control surfaces are formed at a pilot-operated piston, wherein the pressure prevailing in the other pressure chamber (for instance on the piston rod side) is applied to a smaller control surface and the pressure prevailing in the other pressure chamber of the consumer (for instance cylinder chamber) is applied to the larger control surface—then the tensioning piston can be dispensed with.

For maintenance purposes or the like the pressure relief valve includes an emergency opening through which the inlet terminal can be directly connected to the tank terminal.

The control valve arrangement used in the control arrangement comprises, in a preferred embodiment, a metering orifice formed by a continuously variable directional control valve to which an LUDV (load-pressure independent flow distribution) pressure regulator is connected. It is especially preferred when pressure fluid is supplied via a pump the delivery rate of which is adjustable in response to the maximum load pressure of the entire system—the control arrangement then constitutes an LUDV system.

Other advantageous further developments are the subject matter of further subclaims.

Hereinafter preferred embodiments of the invention are illustrated in detail by way of schematic drawings, in which

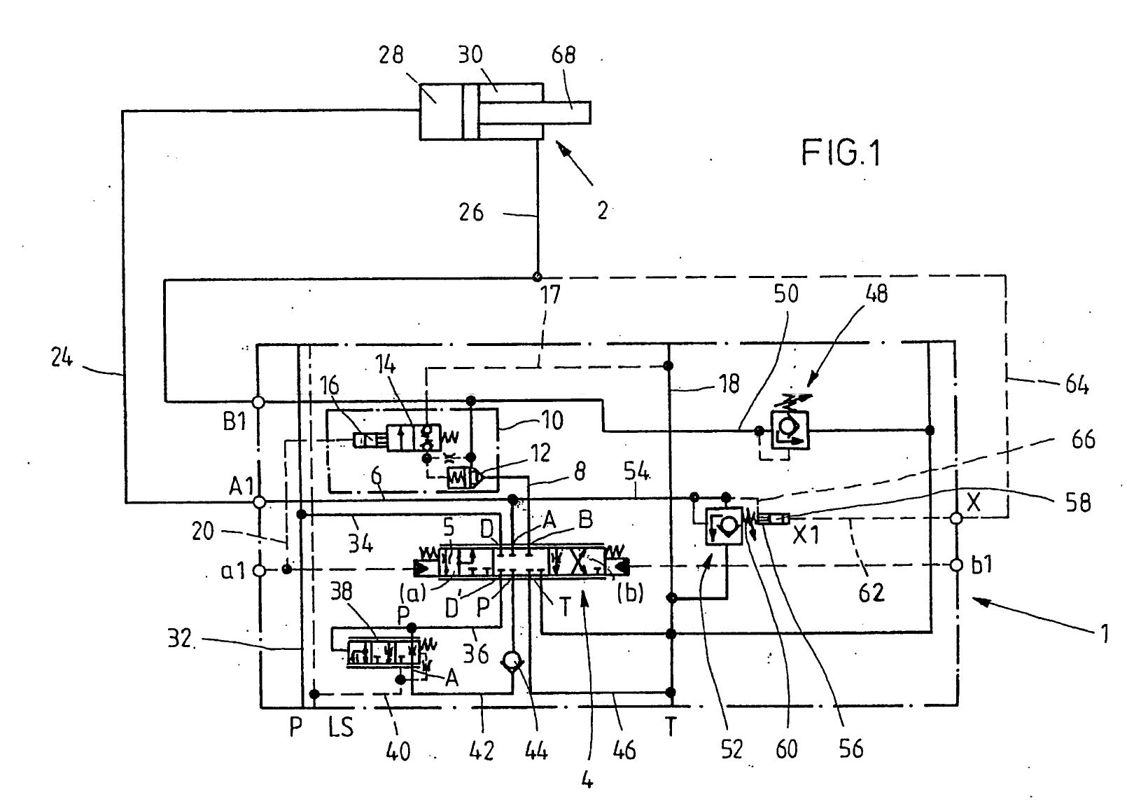

FIG. 1 shows a circuit diagram of a hydraulic control arrangement according to the invention;

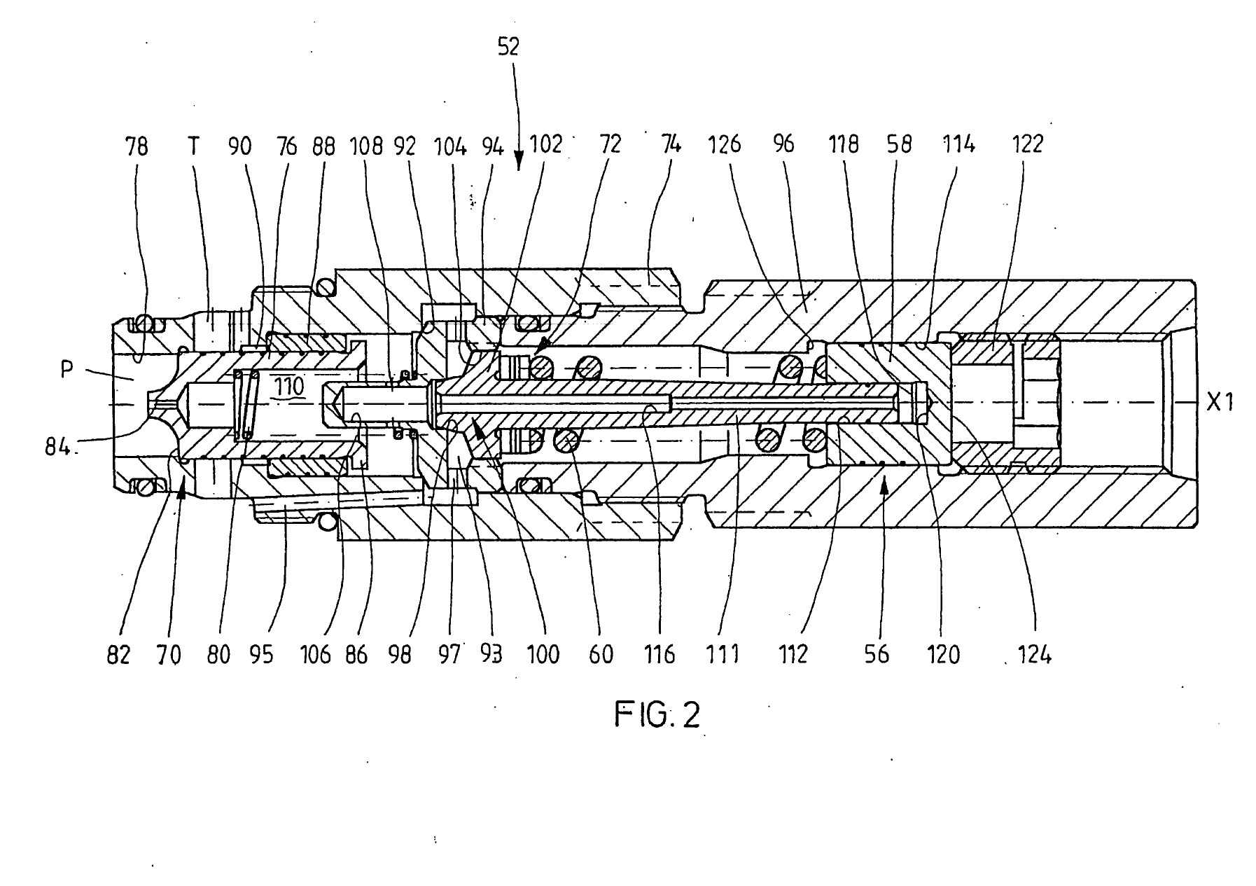

FIG. 2 is a longitudinal section across a pilot-operated pressure relief valve including a tensioning piston of the control arrangement from FIG. 1;

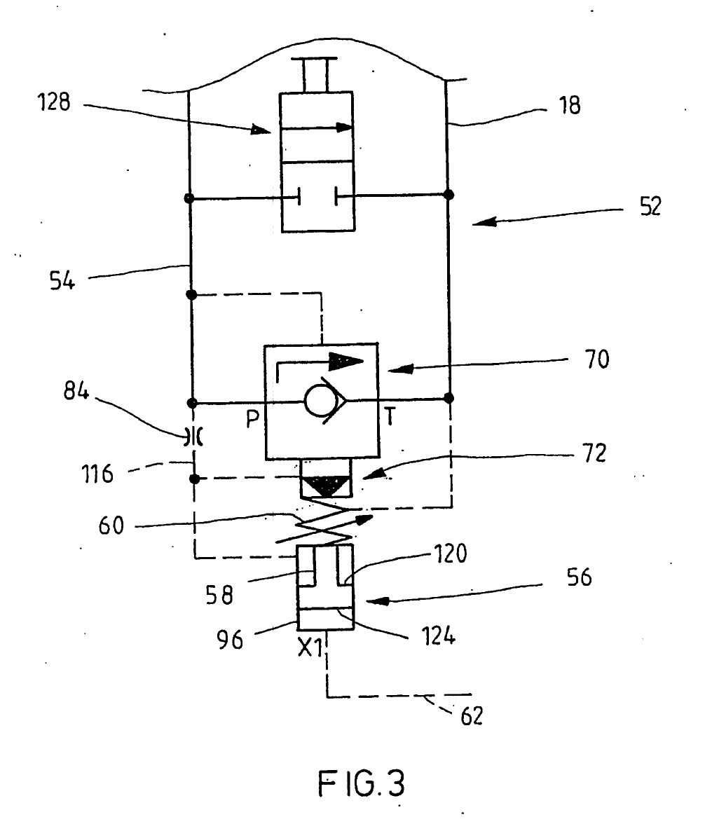

FIG. 3 is a circuit symbol of the pressure relief valve from FIG. 2;

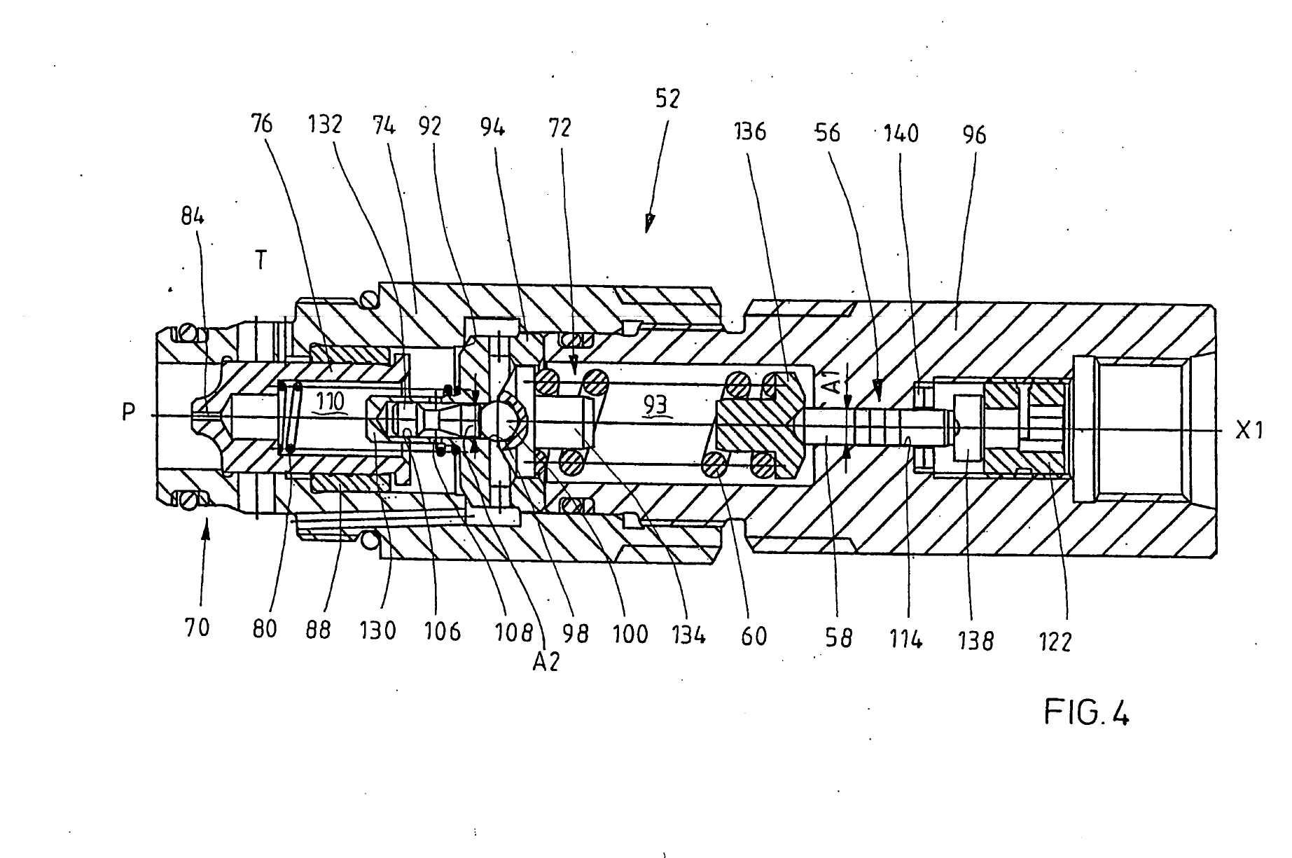

FIG. 4 shows a longitudinal section across another pressure relief valve including a tensioning piston;

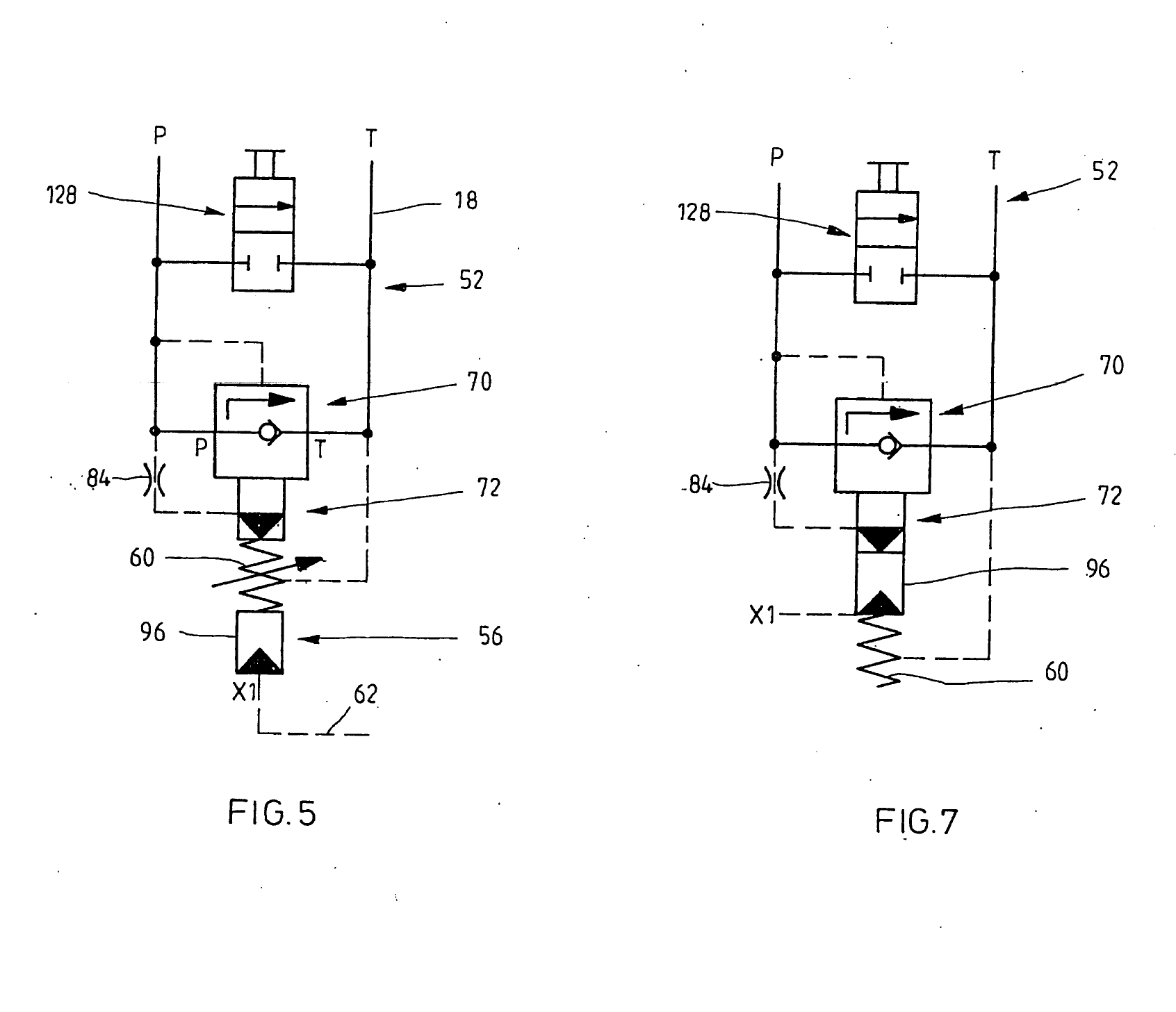

FIG. 5 is a circuit symbol of said pressure relief valve;

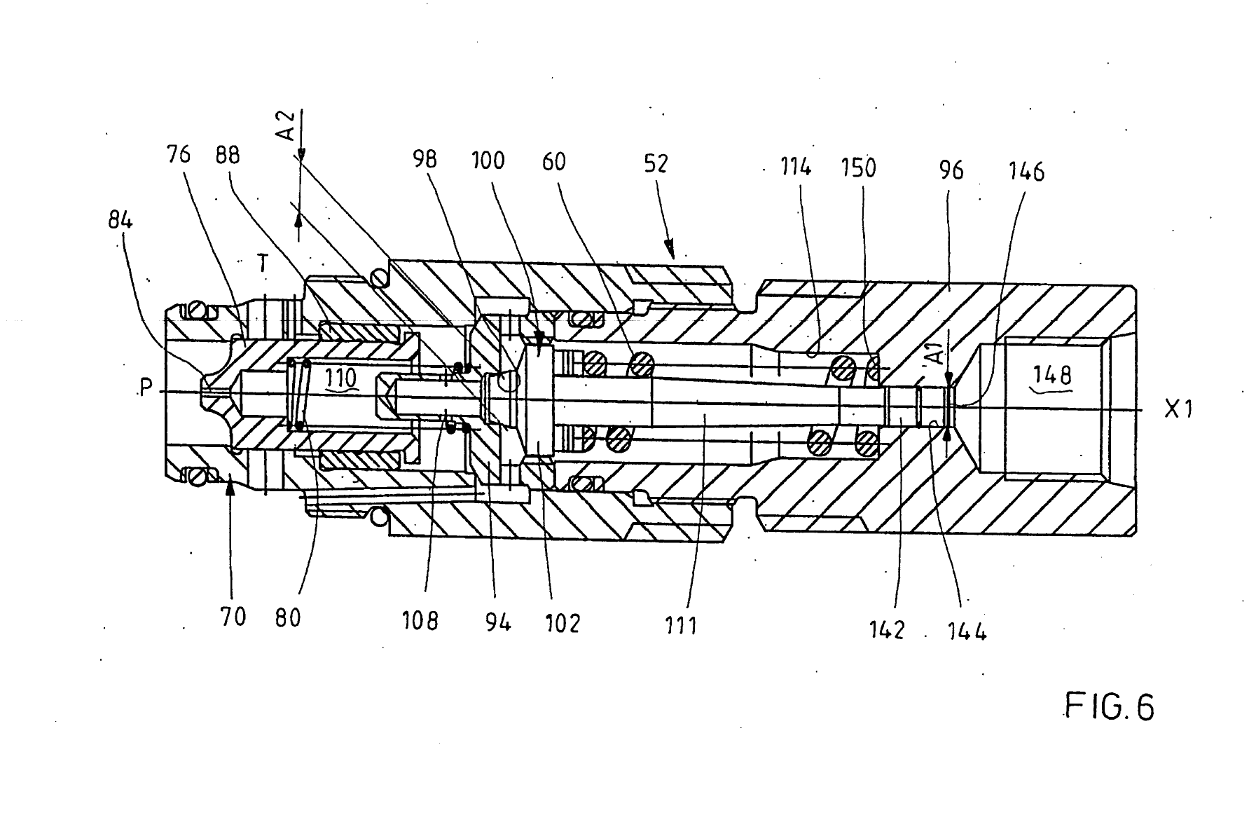

FIG. 6 shows a longitudinal section across an embodiment of a pressure relief valve without a tensioning piston;

FIG. 7 is a circuit symbol of said embodiment and

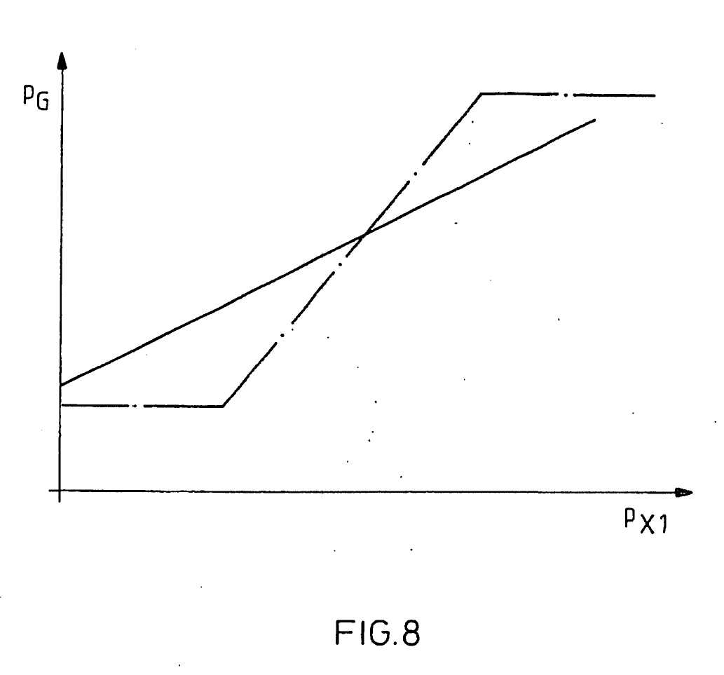

FIG. 8 shows characteristic lines of the pressure relief valves represented in FIGS. 2, 4 and 6.

In FIG. 1 a circuit diagram of a directional control valve element 1 of a mobile control block is contained by which plural consumers of a mobile working implement, for instance a wheel loader, can be controlled. The directional valve element 1 of the mobile control block shown in FIG. 1 serves for controlling an actuating cylinder 2 by which a shovel supported at a boom can be swiveled.

The directional control valve element 1 designed in frameless construction includes a pressure terminal P, a tank terminal T, two working terminals A1, B1 as well as two control terminals a1, b1, a further control terminal x and an LS terminal LS. In the shown embodiment the control block is a LUDV system by which a load-pressure independent flow distribution is permitted. In such LUDV systems a pump having a variable delivery rate, for instance a variable-delivery pump is controlled in response to the maximum load pressure of the consumers.

The LUDV directional control valve element 1 includes a continuously variable directional control valve 4 to the valve slide of which a control pressure can be applied via the two control terminals a1, b1 by and which, thus, is movable from a spring-biased central locking position into a plurality of control positions marked by (a) or (b). The directional control valve 4 has at least a pressure terminal P, a tank terminal T, two working terminals A, B as well as two further terminals D and D′. The directional control valve 4 forms a directional member indicated by the two intersecting or branching arrows and a velocity member formed by a variable metering orifice 5 which is located between the terminals D and D′.

The two working terminals A, B of the directional control valve 4 are connected to the working terminal A1 and to the working terminal B1, respectively, via working lines, hereinafter referred to as advance line 6 and return line 8. Between the working terminal B of the directional valve 4 and the working terminal B1 a low-leak valve 10, as it is called, which basically consists of a logic valve 12 and a pilot valve 14, is arranged in the return line 8. The logic valve includes a stepped valve body loaded in the closing direction by a spring accommodated in a spring chamber. The spring chamber is connected to the working terminal B1 of the directional control valve element via a throttle. The pilot valve 14 is biased in a locking position and can be switched by means of an actuating piston 16 from said locking position into a through-position in which the spring chamber of the logic valve 12 is connected via a tank control passage 17 to a tank passage 18 connected to the tank terminal T so that the spring chamber of the logic valve 12 is pressure-relieved. The stepped valve body of the logic valve 12 thus can be lifted off its valve seat during a pressure fluid flow in the return line 8 toward the actuating cylinder 2 already due to a check function and during a discharge of pressure fluid from the actuating cylinder 2 toward the terminal B of the directional valve upon relief of the spring chamber. The pressure prevailing at the control terminal a1 is applied to the actuating piston 16 via a control branch passage 20, wherein a comparatively large force is applied to the pilot switching valve 14 by virtue of a large surface of the actuating piston 16. Since the structure of such a low-leak valve 10 is known, further respective details can be dispensed with.

The two working terminals A1, B1 of the directional control valve element 1 are connected to a bottom side cylinder chamber 28 and to a piston rod side annular chamber 30, resp., of the actuating cylinder 2 in the form of a differential cylinder via working lines 24, 26.

Moreover, a pump passage 32 connected to the pressure terminal P passes through the directional control valve element 1. A feed passage 34 leading to the terminal D of the directional valve 4 branches off said pump passage. The terminal D′ of the directional control valve is connected via a connecting passage 36 to an inlet terminal P of a LUDV pressure regulator 38 to the pressure regulator piston of which the pressure prevailing in the connecting passage 36 is applied in the opening direction and, in the closing direction, the force of a spring as well as the maximum load pressure of the actuated consumers is applied which is tapped off by a LS passage 40 connected to the LS terminal LS.

Thus, the pressure downstream of the metering orifice 5 is applied to the pressure regulator in the opening direction. An output terminal A of the pressure regulator 38 is connected to the inlet terminal P of the directional control valve 4 via a pressure regulator passage 42 and a check valve 44. The tank terminal T is connected to the tank passage 18 by means of a discharge passage 46.

The pressure prevailing in the return line 8 connected to the annular chamber 30 is restricted via a secondary pressure relief valve 48 which is disposed in a relief passage 50 branching off the return line 8 in the area of the pressure fluid flow path between the logic valve 12 and the allocated working terminal B1 and being connected to the tank passage 18. The pressure protection of the advance line 6 connected to the cylinder chamber 28 is carried out via a pilot-operated pressure relief valve 52 arranged in a passage 54 likewise connected to the tank passage 18 which branches off the advance line 6 in the area between the directional control valve 4 and the working terminal A1.

The pilot-operated pressure relief valve 52 and the pressure relief valve 48 are designed to have a respective sucking function so that pressure fluid can be sucked from the tank passage 18 in order to avoid cavitations in the case of a drawing load.

The pilot-operated pressure relief valve 52 consists, as will be explained in detail hereinafter in FIGS. 2 and 3, of a main stage, a pilot stage as well as a pressure switching stage 56. The latter permits to vary the pressure adjusted at the pilot-operated pressure relief valve 52. Said pressure switching stage 56 schematically shown in FIG. 1 has a tensioning piston 58 at which a control spring 60 of the pilot stage is supported. The pressure prevailing in a pilot passage 62 leading to the control terminal X of the directional control valve element 1 which, in turn, is connected via a line 64 to the working line 26 leading to the annular chamber 30 is applied to a larger control surface of the tensioning piston 58. The pressure prevailing in the advance line 6 which is tapped off via the passage 54 as well as via a tapping passage 66 acts upon a comparatively small control surface of the tensioning piston 58.

For extending a piston rod 68 the directional control valve 4 is brought into one of its positions marked by (a) by applying a control pressure to the control terminal a1. Said control pressure can be adjusted, for instance, via pressure relief valves reducing the pressure in a control circuit to an appropriate control pressure.

The pressure fluid then flows from the variable-delivery pump through a not represented pump line to the pressure terminal P and from there through the pump passage 32, the feed passage 34 to the terminal D of the directional control valve, from there through the metering orifice 5 adjusted according to the control pressure to the terminal D′ of the directional control valve 4 and through the connecting passage 36 to the terminal P of the LUDV pressure regulator 38. Said LUDV pressure regulator 38 disposed downstream of the metering orifice 5 throttles the pressure fluid volume flow so strongly that the pressure downstream of all metering orifices of the system is equal and preferably corresponds to the maximum load pressure or is slightly above the latter. I.e. in the case of a poor supply of plural consumers nothing is changed about the pressure downstream of the metering orifices. Upstream of all metering orifices of the system in the same way the pump pressure is prevailing so that the pressure difference at all metering orifices varies in the same way when the pump pressure is reduced in the case of poor supply—the flow distribution between the metering orifices is maintained (load-pressure independent flow distribution).

The pressure fluid volume flow throttled in this way then flows via the pressure regulator passage 42, the inlet terminal P and the working terminal A of the directional control valve 4 as well as the advance line 6 and the working line 24 to the cylinder chamber 28. The piston rod 68 extends, wherein the pressure fluid displaced from the annular chamber 30 flows off through the working line 26 and the working terminal B1. By the control pressure prevailing at the control terminal a1 the pilot valve 14 is brought from its spring-biased locking position into its through-position so that the spring chamber of the logic valve 12 is relieved and the latter is opened by the pressure prevailing in the discharge line 8 so that the pressure fluid flows further to the working terminal B of the directional control valve 4 and there is added to the pressure fluid volume flow supplied by the pump. The tank terminal T is blocked in the positions (a). The pilot-operated pressure relief valve 52 remains set to a comparatively high pressure which is to be, for instance, 380 bar. As will be explained in detail hereinafter, said higher pressure is adjusted by the fact that the pressure prevailing in the annular chamber 30 which in the differential circuit is at least as high as the pressure prevailing in the cylinder chamber 28 pressurizing the smaller control surface of the tensioning piston 58 acts upon the larger control surface of the tensioning piston 58.

For retracting the piston rod 68 the directional control valve 4 is displaced into one of its positions marked by (b) by applying a control pressure to the control terminal b1, wherein then the cylinder chamber 28 is connected to the tank passage 18 and the annular chamber 30 is connected to the pump passage 32 so that pressure fluid is supplied into the annular chamber 30 and the pressure fluid displaced from the cylinder chamber 28 flows back to the tank T.

It is assumed that a ground is to be drawn off as described in the beginning. As stated, the piston rod 68 is extended for this purpose (directional control valve in position (a)) and thus the shovel is completely swiveled and subsequently the directional control valve is reset into its spring-biased central position. The shovel then rests on the ground and the wheel loader drives in reverse travel to draw off the ground. When the shovel hits an obstacle, the piston rod 68 is pressurized in the retracting direction, whereby the pressure prevailing in the annular chamber 30 and, correspondingly, the pressure prevailing in the control passage 62 is reduced. By said reduction of pressure in the annular chamber 30 the tensioning piston 58 is moved in the relief direction of the control spring 60 by the action of the control spring 60 and the pressure in the cylinder chamber 28 acting upon the smaller control surface. The tensioning piston 58 is moved to the rear against a stop and the control spring 60 is relieved so that the pressure relief valve is adjusted to a substantially lower pressure of, for instance, 100 bar. When said pressure in the cylinder chamber 28 is exceeded, the pilot-operated pressure relief valve 52 opens so that the piston rod 68 is prevented from being damaged by excessive compressive load.

The pilot-operated pressure relief valve 52 used will be illustrated hereinafter by way of the FIGS. 2 and 3.

FIG. 2 shows a longitudinal section of the pilot-operated pressure relief valve 52 according to the invention. As mentioned already, the latter has a main stage 70, a pilot stage 72 as well as the pressure switching stage 56. The basic structure of the main stage 70 and the pilot stage 72 is substantially known from DE 100 62 427 A1 so that here only the components necessary for the comprehension of the invention are described and, for the rest, it is referred to said prepublished document. The pilot-operated pressure relief valve 52 is in cartridge design and includes a housing 74, at which a front-end pressure terminal P and a radial tank terminal T formed by a bore star, for instance, are formed. In the housing 74 a valve slide 76 designed to have a sliding fit is guided in a valve bore 78, the valve slide being biased against a fitting edge 82 by a weak pressure spring 80. In the shown closing position the connection between the inlet terminal P and the tank terminal T is blocked. The valve slide 76 is hollow, wherein in an axially projecting end face a nozzle bore 84 is formed which extends inwardly to a spring chamber 110 for the pressure spring 80. At the rear side of the valve slide 76 disposed on the right in FIG. 2 a radial collar 86 is formed. The latter constitutes a stop for a suction ring 88 guided in an annular chamber between a radially extended portion of the valve bore 78 and the outer circumference of the valve slide 76 in a sealing manner. The pressure prevailing at the tank terminal T is applied to the end face of the suction ring 88 on the left in FIG. 2 via a throttle gap 90.

In the radially extended portion of the valve bore 78 a sealing edge 92 is formed which contacts a seat member 94 inserted in a once more extended portion of the valve bore 78. Said seat member is biased against the sealing edge 92 by means of a pilot housing 96 screwed into the housing 70. At the seat member 94 a pilot valve seat 98 is formed against which a pilot valve cone 100 is biased by the control spring 60. For the purpose of axial guiding the pilot valve cone 100 has a collar 102 the outer circumference of which is guided in a guiding bore 104 of the seat member 94 provided with two longitudinal grooves. At the end face of the seat member 94 on the left in FIG. 2 an axial projection is formed in which a blind hole bore 106 closed to the left is provided which extends toward the pilot valve seat 98 and which is connected to the spring chamber 110 for the pressure spring 80 via radial bores 108. The chamber 93 formed on the right from the seat 92 in FIG. 2 is connected to the tank terminal T via an inclined passage 95. Said chamber 93 is moreover connected to the chamber enclosed by the seat member 94 also via connecting bores 97. Through the longitudinal grooves provided in the guiding bore 104 of the seat member 94 also the chamber accommodating the control spring 60 is connected to the tank.

A projection 111 whose end portion immerses in a recess 112 of the tensioning piston 58 which is guided to be axially movable in a through-bore 114 of the pilot housing 96 extends from the collar 102 of the pilot valve cone 100 to the right. Said through-bore 114 extends coaxially with respect to the valve bore 78. A longitudinal passage 116 which opens in the control chamber 118 delimited by the recess 112 and the projection 111 passes through the pilot valve cone 100 and the projection 111 thereof. I.e. the pressure prevailing in the spring chamber 110 is tapped off via the longitudinal passage 116 and the radial bores 108 and acts upon a comparatively small control surface 120 formed by the end face of the recess 112.

The control spring 60 is supported at the end face of the tensioning piston 58 on the left in FIG. 2 so that the latter is adjacent to a stop screw 122 screwed in the through-bore 114 in its shown home position. The through-bore 114 opens at the right end face of the pilot housing and forms a terminal X1 of the pilot-operated pressure relief valve 52 to which the control passage 62 shown in FIG. 1 is connected. The stop screw 122 has an annular shape so that the pressure prevailing at the control terminal X1 also acts upon the rear side of the tensioning piston 58 forming a control surface 124 which is considerably larger compared to the control surface 120.

At a distance on the left from the tensioning piston 58 a radial shoulder acting as stop 126 which delimits the axial travel of the tensioning piston 58 to the left (FIG. 2) is formed at the through-bore 114.

The circuit symbol of the pressure relief valve 52 shown in FIG. 2 is shown strongly schematized in FIG. 3. There are shown the main stage 70, the pilot stage 72 as well as the pressure switching stage 56 including the tensioning piston 58 and the pilot housing 96. The pressure prevailing in the control passage 62 is applied to the larger control surface 124 of the tensioning piston 58 and the pressure prevailing at the inlet terminal P is applied to the smaller control surface 120, the pressure being tapped off via the longitudinal passage 116 as well as the spring chamber 110 and the nozzle bore 84 (cf. FIG. 2). In FIG. 3 merely the reference numeral for the longitudinal passage 116 is shown.

The tensioning piston 58 acts upon the control spring 60 which pressurizes the valve slide 76 of the main stage 72 in the closing direction. In the opening direction the pressure prevailing at the inlet terminal P which is also prevailing in the passage 54 and in the advance line 6 acts upon the valve slide 76.

For maintenance purposes the pressure terminal P of the pressure relief valve 52 can be manually connected to the tank terminal T. This is indicated in FIG. 3 by the manually operable switching valve 128. When switching said switching valve 128 into its through position, the inlet terminal P of the pressure relief valve 52 is relieved toward the tank passage 18. In the concrete embodiment shown in FIG. 2 said emergency opening is formed by the interaction of the seat member 94 and the sealing edge 92.

When the pilot housing 96 is completely screwed in, the seat member 94 rests fixedly on the sealing edge 92—this corresponds to the closed position of the switching valve 128 (cf. FIG. 3). For the emergency opening the manually reachable pilot housing 96 is somewhat screwed out of the housing 74 so that the seat member 94 lifts off the sealing edge 92 and the spring chamber 110 in which usually the pressure prevailing at the inlet terminal P is applied is connected to the tank terminal T or, more exactly speaking, to the tank passage 18 via the inclined passage 95—the valve slide 76 can be displaced to the right by the pressure prevailing at the inlet terminal P against the force of the comparatively weak compressive spring 80 so that the connection to the tank terminal T is opened.

In the event that—for instance in the case of a pulling load—the pump is not adapted to supply sufficient pressure fluid to the cylinder chamber 28 and thus the respective load pressure falls below the tank pressure, the suction ring 88 is displaced to the right by the higher tank pressure and abuts against the radial collar 86 so that the valve slide 76 is caught and the connection from the tank terminal T to the inlet terminal P is opened so that pressure fluid can be re-sucked from the tank.

As already explained by way of FIG. 1, the pressure prevailing in the annular chamber 30, which in the differential circuit (control positions (a) of the directional control valve 4) is at least as high as the pressure prevailing in the cylinder chamber 28, acts during normal operation, for instance when swiveling or tilting the shovel, i.e. upon extension of the piston rod 68. That is to say, the pressure acting upon the larger control surface 124 is at least equal to the pressure acting upon the smaller control surface 120 which corresponds to the pressure in the cylinder chamber 28. The force acting in the one direction upon the tensioning piston is the sum of the force of the control spring 60 plus the compressive force generated by the pressure prevailing in the spring chamber 110 at the control surface 120 which is equal to the cross-sectional surface of the projection 111 inside the recess 112. The spring force in turn is equal to a compressive force generated by the limit pressure at a surface which is the differential surface between the cross-sectional surface of the pilot valve cone 100 at the seat 98 and the control surface 120. Finally, the force acting upon the tensioning piston in the one direction upon reaching the higher limit pressure corresponds to a compressive force generated by the higher limit pressure at the cross-sectional surface of the pilot valve cone at the seat 98.

In the opposite direction a compressive force generated at the control surface 124 by the pressure prevailing in the terminal X1 acts upon the tensioning piston 58.

Assuming the surface ratios from FIG. 2, with a predetermined pressure prevailing in the terminal X1 an approximately six times higher limit pressure can be adjusted, wherein the maximum limit pressure is given when the tensioning piston is adjacent to the stop 126 and the control spring 60 is biased in that case. If the predetermined pressure is reached at the terminal X1, the tensioning piston 58 is displaced from the position in FIG. 2 to the left until it abuts against the stop 126. In this way the control spring 60 is tensioned—at the pilot-operated pressure relief valve 52 the higher pressure is adjusted. In order to adjust 390 bar, in the terminal X1 65 bar, for instance, are sufficient. When drawing off the ground and when an external load pressurizes the piston rod 68 in the retracting direction, the pressure in the annular chamber 30 is reduced, unless it has already been the tank pressure, while the pressure in the cylinder chamber 28 increases. The geometry of the tensioning piston 58 is selected such that from a particular difference in pressure between the pressure chambers 28, 30 the tensioning piston 58 lifts off the stop 126 by the relief of the control surface 124 and is moved against the stop screw 122. Said reverse movement is supported by the pressure acting upon the smaller control surface 120—the bias of the control spring 60 is reduced and, correspondingly, the release pressure of the pilot-operated pressure relief valve 52 is adjusted to a lower pressure (100 bar). Said pressure is selected such that a damage of the piston rod 68 can be reliably avoided. Below a particular pressure prevailing in the terminal x1 the tensioning piston 58 is adjacent to the stop screw 122 even in the case of tank pressure prevailing in the cylinder chamber 28, namely when the compressive force is less than the force of the relieved spring 60.

The small control surface 120 of the tensioning piston 58 has the effect that upon reaction of the pressure relief valve 52 a force which is as great as the force generated by the inlet pressure (P) at the entire seat surface of the pilot valve seat 98 is applied to the tensioning piston 58 in the direction of relief of the control spring 60. However, only the differential surface between the valve seat surface and the small control surface 120 is relevant to the control spring 60 so that the pressure prevailing in the annular chamber 30 of the actuating cylinder 2 has to drop relatively strongly so that the pressure relief valve reacts. In the case of a pressure relief valve 52 having the geometrical proportions shown in FIG. 2, with an assumed limit pressure of 360 bar, for instance, a pressure prevailing in the annular chamber 30 and, correspondingly, a pressure acting upon the larger control surface 124 of approx. 60 bar would be sufficient to hold the tensioning piston 58 at the stop 126. Only when the pressure falls below said 60 bar, the pressure relief valve 52 opens, wherein in that case at a pressure of approx. 20 bar the tensioning piston 58 abuts against the stop screw 122 and thus determines the lower limit pressure which then would be approximately 120 bar.

By way of FIG. 4 an embodiment is illustrated in which the pressure relief valve 52 already reacts in the case of a considerably lower pressure drop in the annular chamber 30 of the actuating cylinder 2. This is substantially achieved in the embodiment shown in FIG. 4 by the fact that the additional smaller control surface 120 is dropped and the surface ratio between the active diameter of the tensioning piston 58 and the pilot valve seat diameter is selected to be substantially smaller than in the above-described embodiment. Said surface ratio is about 1.12 in the embodiment shown in FIG. 4, i.e. the pilot valve seat surface A₂ is larger by 1,12 times than the active surface A₁ of the tensioning piston 58.

The basic structure of the embodiment represented in FIG. 4 corresponds to that from FIG. 2. Accordingly, also the embodiment shown in FIG. 4 is designed to include a main stage 70, a pilot stage 72 and a pressure switching stage 56. The main stage 70 including the valve slide 76, the compression spring 80, the cartridge-shaped housing 74 and the suction ring 88 corresponds to the main stage 70 of the afore-described embodiment so that, to simplify matters, it is referred to the respective statements. The pilot stage 72 and the switching stage 56 are substantially integrated in the pilot housing 96 which is screwed into the cartridge-shaped housing 74 and urges the seat member 94 against the sealing edge 92 (in the shown home position). Similarly to the afore-described embodiment, the sealing member 94 includes an axial projection 130 in which the blind bore hole 106 is formed which opens in the spring chamber 110 via the radial bores 108. In the blind bore hole 106 of the seat member 94 a small damping piston 132 which permits a pressure fluid connection in the direction of the pilot valve seat 98 by means of damping gaps (not shown in detail in FIG. 4) is guided to be axially movable.

In said embodiment a spherical pilot valve body which, to simplify matters, is likewise denoted with pilot valve cone 100 is biased against said pilot valve seat 98. Said pilot valve cone is supported by a mushroom-type spring plate 134 upon which the control spring 60 acts which in turn is supported at the tensioning piston 58 by means of a further spring plate 136. The outer circumference of the mushroom-type spring plate 124 is guided inside the seat member 94. The chamber 93 accommodating the control spring 60 is connected to the tank terminal T—as in the above-described embodiment—.

In the shown home position the tensioning piston 58 is adjacent to the stop screw 122 screwed into the pilot housing 96 with a stop head 138 extended in radial direction so that the pressure prevailing at the control terminal X1 (pressure in the annular chamber 30) is applied to the tensioning piston 58 in the direction of an increase in the bias of the control spring 60. The tensioning piston 58 is guided, as in the afore-described embodiment, along a through-bore 114 of the pilot housing 96. Said through-bore 114 is extended to the right (view according to FIG. 4) to the terminal X1, wherein at an annular shoulder a stop member 140 is supported which, in its effect, corresponds to the stop 126 and thus restricts the axial stroke of the tensioning piston 58 to the left in FIG. 4. The active control surface A₁ to which the pressure prevailing at the control terminal X1 is applied is defined by the outer diameter of the radially reset part of the tensioning piston. When extending the piston rod 68 (in differential circuit) as described before, thus the pressure prevailing in the annular chamber 30 acts upon the resulting active surface A₁ of the tensioning piston 58 so that with a sufficient pressure prevailing in the annular chamber 30 the tensioning piston 58 is moved out of its shown home position to the left, until the stop head 138 abuts against the stop member 140 and the control spring 60 is tensioned—the upper limit pressure is adjusted.

The pilot stage 72 opens when the pressure active at the pilot valve seat 98 is sufficient to lift the pilot valve cone 100 off the pilot valve seat 98. In the opening direction the pressure prevailing at the pressure terminal P, which is tapped off via the nozzle bore 84, the spring chamber 110, the radial bores 108 and the damping gap delimited by the small damping piston 106, acts upon the pilot valve seat 98 having the cross-sectional surface A₂. In the represented embodiment the surface ratio A₁/A₂ is relatively small (for instance 1,12) so that the pilot stage 72 is opened already with a substantially higher pressure prevailing in the annular chamber 30 than in the afore-described embodiment. Assuming, for example, that the limit pressure amounts to 380 bar, the pressure relief valve would correspondingly open at a pressure of approx. 340 bar—i.e. by far earlier than in the embodiment shown in FIG. 2—. Said early opening is further assisted by the fact that in the embodiment shown in FIG. 4 a control surface (120 in FIG. 2) active in the direction of relief of the control spring 60 is missing. If in this embodiment the pressure prevailing in the annular chamber 30 continues dropping, for instance to 110 bar, the stop head 138 gets into contact with the stop screw 122 so that the lower limit pressure (minimum bias of the control spring 60) is adjusted. According to the surface ratio A₁/A₂, said minimum limit pressure corresponds, in the embodiment according to FIG. 4, to approx. 123 bar. In the ranges lying therebetween, i.e. in the case of pressures prevailing in the annular chamber 30 between 110 and 340 bar, the limit pressure increases in a linear manner in accordance with said surface ratio.

The circuit symbol of the embodiment shown in FIG. 4 is illustrated in FIG. 5. Said circuit symbol substantially corresponds to that of FIG. 3, the pressure switching stage 56 having no control surface 120 active in the direction of relief of the control spring 60. The shown control oil nozzle is formed by the nozzle bore 84 as in the embodiment according to the FIGS. 2 and 3.

FIG. 6 shows a further simplified embodiment of a pressure relief valve in accordance with the invention in which the use of a tensioning piston is dispensed with.

The basic structure of the valve is identical to the embodiment described by way of FIG. 2, apart from the guide and the structure of the pilot valve cone 100, so that, regarding the description of the main stage 70 including the valve slide 76, the pressure spring 80 and the suction ring 88 as well as regarding the seat member 94 and the pilot housing 96 screwed into the housing 74 of the main stage 70, reference is made to the remarks on FIG. 2. The outer contour of the pilot valve cone 100 likewise corresponds to the embodiment shown in FIG. 2, i.e. to the right a non-hollow projection 111 whose cylindrical end portion 142 passes through a guiding portion 144 of the pilot housing 96 formed by a radially reset part of the through-bore 146 is connected to the collar 102 guided in the seat member 94. The end face 146 of the pilot valve cone 100 on the right in FIG. 6 delimits a control chamber 148 to which the control oil pressure prevailing at the control terminal X1 is applied. As in the embodiment according to FIG. 2, the pilot valve cone 100 is biased via the control spring 60 against the pilot valve seat 98 the active surface of which is denoted with the cross-sectional surface A₂ in the representation according to FIG. 6, while the active surface of the end face 146 in FIG. 6 is characterized by A₁. The control spring 60 is supported at a fixed annular end face 150 of the pilot housing 96.

In this embodiment the two limit pressures are defined by the ratio of the surfaces A₁/A₂. In the case in which the pressure in the annular chamber 30 is approximately zero, accordingly also the pressure at the control terminal X1 and thus also the pressure prevailing in the control chamber 148 is approximately zero so that no control oil pressure is applied to the end face 146—the pilot valve cone 100 is thus biased solely by the force of the control spring 60 against its pilot valve seat 98 so that the lower limit pressure is adjusted. When in a differential circuit the pressure prevailing in the annular chamber 30 is substantially equal to the pressure prevailing in the cylinder chamber 28 of the actuating cylinder 2, the same pressure is applied both to the end face 146 and to the end face portion of the pilot valve piston 100 delimited by the pilot valve seat 98 so that said pressure is active at the surface difference A₁-A₂ and the upper limit pressure is adjusted.

The circuit symbol of the pressure relief valve 52 shown in FIG. 6 is represented in FIG. 7. Accordingly, in this embodiment the bias of the control spring 60 is not varied but merely the compressive forces acting upon the pilot operation in the opening and closing direction, wherein a change of the pressure prevailing at the control terminal X1 always results in a change of the adjusted limit pressure, too. If said limit pressure P_{G} adjusted at the pressure relief valve 52 is plotted as a function of the pressure P_{X1} prevailing at the control terminal X1 (pressure prevailing in the annular chamber 30), the characteristic represented by a continuous line in FIG. 8 is resulting. Accordingly, in an embodiment according to FIG. 6 (continuous line in FIG. 8) the areas in which a change of the pressure P_{X1} has no influence on the adjusted limit pressure P_{G}, while in the embodiments according to the FIGS. 2 and 4 the upper and lower limit pressures are characterized by the horizontally extending portions in which a change of the control pressure P_{X1} has no influence (dash-dotted line). The linear increase therebetween is substantially dependent on the afore-described surface difference of the active control surfaces.

The invention relates to a hydraulic control arrangement and a pilot-operated pressure relief valve therefor. Said hydraulic control arrangement comprises a differential cylinder provided with a pressure chamber on the piston rod side thereof and another pressure chamber at the bottom thereof which can be connected to a pump or a tank by means of a control valve arrangement in order to actuate the differential cylinder. The pressure in a pressure chamber is defined by a pilot-operated pressure relief valve provided with a pressure switching stage by which means the pressure regulated by the pressure relief valve can be lowered according to the pressure in the other pressure chamber.

List of Reference Numerals:

1 Directional control valve element
2 actuating cylinder
4 directional control valve
5 metering orifice
6 advance line
8 return line
10 low-leak valve
12 logic valve
14 pilot valve
16 actuating piston
17 tank control passage
18 tank passage
20 control branch passage
24 working line
26 working line
28 cylinder chamber
30 annular chamber
32 pump passage
34 supply passage
36 connecting passage
38 LUDV pressure regulator
40 LS passage
42 pressure regulator passage
44 check valve
46 discharge passage
48 pressure relief valve
50 relief passage
52 pilot-operated pressure relief valve
54 passage
56 pressure switching stage
58 tensioning piston
60 control spring
62 control passage
64 line
66 tapping passage
68 piston rod
70 main stage
72 pilot stage
74 housing
76 valve slide
78 valve bore
80 compression spring
82 fitting edge
84 nozzle bore
86 radial collar
88 suction ring
90 throttle gap
92 sealing edge
93 chamber
94 seat member
95 inclined passage
96 pilot housing
97 connecting bore
98 pilot valve seat
100 pilot valve cone
102 collar
104 guiding bore
106 blind hole bore
108 radial bore
110 spring chamber
111 projection
112 recess
114 through-bore
116 longitudinal passage
118 control chamber
120 small control surface
122 stop screw
124 larger control surface
126 stop
128 switching valve
130 axial projection
132 small damping piston
134 spring plate
136 further spring plate
138 stop head
140 stop member
142 end portion
144 guiding portion
146 end face
148 control chamber
150 annular end face

1. A hydraulic control arrangement comprising a differential cylinder having a first pressure chamber and a second pressure chamber which can be connected to a pump or a tank by means of a control valve arrangement in order to actuate the differential cylinder, characterized by a pilot-operated pressure relief valve for defining the pressure in one of the pressure chambers, wherein a control surface to which the pressure prevailing in the other one of the pressure chambers is applied is provided in a pilot stage of the pressure relief valve.

2. A hydraulic control arrangement according to claim 1, wherein the first-mentioned pressure chamber is a cylinder chamber on the bottom side and the other pressure chamber is an annular chamber on the piston rod side.

3. A hydraulic control arrangement according to claim 2, wherein the two pressure chambers can be connected to each other by means of the control valve arrangement in order to actuate the differential cylinder in the differential circuit.

4. A hydraulic control arrangement according to claim 1 wherein the pilot stage comprises a tensioning piston pressurized by a control spring to which the pressure prevailing in the other pressure chamber is applied in the direction of increase in the spring bias.

5. A hydraulic control arrangement according to claim 4, wherein the pressure prevailing in the first-mentioned pressure chamber is applied to a comparatively smaller control surface of the tensioning piston in the direction of relief of the control spring.

6. A hydraulic control arrangement according to claim 5, wherein the surface ratio between the control surface of the tensioning piston and the active surface of the pilot valve seat is less than 4, preferably less than 1.5.

7. A hydraulic control arrangement according to claim 5, wherein a pilot piston of the pressure relief valve is provided with a longitudinal passage through which control oil is guided from a spring chamber of a main stage to the smaller control surface.

8. A hydraulic control arrangement according to claim 7, wherein the pilot piston has a projection which immerses into a recess of the tensioning piston in a sealing manner, the end face of the recess forming the smaller control surface.

9. A hydraulic control arrangement according to claim 1, wherein the control surface is formed at a projection of a pilot piston such that the pressure prevailing in the other pressure chamber acts upon the pilot piston in the closing direction.

10. A hydraulic control arrangement according to claim 9, wherein the projection passes through a spring chamber of the control stage and immerses into a control chamber to which the pressure prevailing in the other pressure chamber is applied.

11. A hydraulic control arrangement according to claim 1, wherein the pilot-operated pressure relief valve includes a manually operable emergency opening.

12. A hydraulic control arrangement according to claim 1, wherein the control valve arrangement comprises a continuously variable directional control valve forming a variable metering orifice with a pressure regulator being connected downstream thereof to which the pressure downstream of the metering orifice is applied in the opening direction and the maximum load pressure is applied in the closing direction.

13. A hydraulic control arrangement according to claim 12, comprising a pump the delivery rate of which is adjustable in response to the maximum load pressure so that a pump pressure is above the maximum load pressure by a particular pressure difference.

14. A pressure relief valve for a control arrangement in accordance with claim 1, comprising an inlet terminal and an outlet terminal and comprising a main stage, a pilot stage including a tensioning piston which acts on a control spring of a pilot valve cone, characterized in that the tensioning piston has a larger control surface to which a control pressure can be applied via a control terminal in the direction of increase in the spring bias, and wherein the pressure prevailing at the inlet terminal is applied to a smaller control surface of the tensioning piston in the direction of reduction of the control spring bias.

15. A pressure relief valve for a control arrangement according to claim 1, comprising an inlet terminal and an outlet terminal and comprising a main stage and a pilot stage, characterized in that a spring-biased pilot valve cone of the pilot stage has a control surface pressurized in the closing direction and a larger control surface active in the opening direction to which the pressure prevailing at the inlet terminal is applied.

16. A pressure relief valve according to claim 14, wherein the surface ratio of the control surface is ≦4, preferably 1<A₁/A₂<1.5.
